(19) United States
(12) Patent Application Publication
(10) Pub. No.: US 2026/0216006 A1
(43) Pub. Date: Jul. 30, 2026

(54) PACIFIER HAVING TEETHING AND SUCTION STRUCTURES

(71) Applicants: Yeugenia Maguire, Boonton, NJ (US); Patrick Maguire, Boonton, NJ (US)

(72) Inventors: Yeugenia Maguire, Boonton, NJ (US); Patrick Maguire, Boonton, NJ (US)

(21) Appl. No.: 19/440,593

(22) Filed: Jan. 5, 2026

Related U.S. Application Data
(60) Provisional application No. 63/741,468, filed on Jan. 3, 2025.

(51) Int. Cl. A61J 17/00

(52) U.S. Cl. CPC A61J 17/111; A61J 17/001

(57) ABSTRACT

The present disclosure describes a pacifier having both teething elements and suction elements in addition to a traditional pacifier nipple. This allows for a multi-functional device that can both soothe a child when upset as well as provide relief when teething. Further, the suction element limits or prevents loss of the pacifier throughout the course of the day when not in use by the child, as the pacifier can be suctioned or adhered to a surface and remain in place until needed.

### CROSS-REFERENCE TO RELATED APPLICATIONS

This is a Non-Provisional Application which claims priority to a co-pending U.S. Provisional Application No. 63/741,468, filed on Jan. 3, 2025, the contents of which are hereby fully incorporated by reference.

### BACKGROUND OF THE EMBODIMENTS

The field of the embodiment relates to pacifiers to soothe young children when upset and/or teething. In particular, the pacifiers of the embodiments of the present invention relate to pacifiers incorporating suction structures as well as teething structures.

Devices for soothing infants as well as in the teething process are commonplace. These devices typically have a guard (to prevent ingestion/choking), a pliable nipple for soothing that allows for deformation when the infant sucks and/or bites down onto the nipple, and a handle. When an infant is teething, the infant may bite down on a harder material, such as a toy or specific teething device, thus helping to urge the infant's teeth through the gum without inflicting pain on the infant.

Pacifiers are known to incorporate, to varying degrees, teething materials. In particular, several of these pacifiers have included a teething ring positioned opposite a nipple to serve both the soothing and teething needs of an infant.

Further, pacifiers often come with or are used with a clip or cord to prevent the pacifier from becoming lost when not in use or when the infant may inadvertently drop the pacifier unbeknownst to the parent or caregiver. In other instances, a parent or caregiver may need to set the pacifier down, and the surrounding environment does not allow for a clear, clean, and convenient place to set down the pacifier. For example, when a parent loads the infant into the car seat, they may need a place to put down the pacifier somewhere other than the car seat and may find themselves putting it in their pocket, mouth, car door, etc. Further, the infant could be playing amongst a mountain of toys, and the parent may not have a place to set down the pacifier that is clear and convenient where the pacifier is not easily lost.

Accordingly, it is a goal to provide a pacifier with a pacifying handle or ring which incorporates at least two different teething materials to increase an infant's teething experience, which different teething materials provide an infant with a different and varied teething feel on his or her gums.

Review of related technology:
U.S. Pat. No. 6,447,536 pertains to a teething pacifier comprising a pacifier guard having two opposing sides, a nipple, and a teething handle. The nipple extends from one side of the pacifier guard, while a connection hub is associated with the opposing side. The teething handle is pivotally connected to the hub, and further includes a first teething material and a second teething material which is at least partially distinct from the first teething material. In one construction, the first teething material is a harder, more rigid material which comprises the handle substrate, and the second teething material is a softer, more compressive material which is overmolded onto the first teething material substrate. In another construction, the softer second teething material forms the handle substrate, and the more rigid first teething material is overmolded onto the second teething material substrate. In either construction, the overmolded teething material may be arranged in bands of decreasing width as they approach the connection hub to direct an infant away from the pacifier guard.
U.S. Pat. No. 6,056,774 pertains a pacifier for infants and the like includes a two-part teethable handle construction having a rigid inner handle member and a soft outer handle member. The rigid inner handle member is connected with the pacifier and has an outer surface shaped for grasping. The soft outer handle member overlies at least a portion of the outer surface of the rigid inner handle member and is securely connected therewith to define a chewable portion of the handle construction adapted for teething.
WO2002064079 pertains to a pacifier comprises a protective plate, a gripping part, and a suction part. The pacifier is manufactured in one single piece from two different materials in one process by molding or injection molding. The transitional regions between the materials are advantageously smooth for preventing the accumulation and growth of bacteria.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### BRIEF SUMMARY OF THE EMBODIMENTS

In general, the present invention and its embodiments provide for a pacifier for a child that has multiple structural elements to enhance the use of the pacifier for the child and help to retain a location of the pacifier for the parent or caregiver. The pacifier has a guard, a nipple, and a suction element (e.g., a suction cup). In some embodiments, the pacifier further has teething elements or structures.

The pacifier may have various bumps, grooves, and the like to serve as the teething element. The teething element may be formed from the same or a different material as the material surrounding the teething element. In some embodiments, the pacifier may be chilled such that the pacifier as a whole or a portion thereof (e.g., the teething element) is chilled to provide relief to a teething infant.

Further, a suction element such as a suction cup can be used to affix the pacifier to an angled surface as needed. The suction cup may be of varying sizes and may have a release mechanism or tab to help release the suction formed between the environment and the cup portion of the suction element. The suction cup may stretch in a way that would allow the infant to play with the pacifier when adhered to the environment or otherwise help to prevent breakage of the pacifier. In some embodiments, the suction cup may be removable. Regardless of the structure of the pacifier, it is preferred to be lightweight such that it can readily be used and manipulated by an infant.

In one aspect, a pacifier includes a guard having a first side and a second side, the guard having one or more rounded edges, a nipple portion coupled to and extending from the first side of the guard, a suction portion coupled to and extending from the second side of the guard, where the suction portion contains an element configured to provide suction when pressed onto a surface, and where the suction portion contains one or more textures disposed thereon. The pacifier may also include where the suction portion contains one or more interior volumes configured to receive a fluid.

The pacifier may also include where the element configured to provide suction is a suction cup.

The pacifier may also include a retraction mechanism coupled to each of the guard and the suction portion.

The pacifier may also include where the one or more textures includes one or more annularly shaped raised bumps.

The pacifier may also include where the suction portion is removable from the guard.

In another aspect, there is a pacifier that includes a guard having a first side and a second side, the guard having one or more rounded edges, a nipple portion coupled to and extending from the first side of the guard, a suction portion coupled to and extending from the second side of the guard, where the suction portion is removable from the guard, where the suction portion contains an element configured to provide suction when pressed onto a surface, and where the suction portion contains one or more textures disposed thereon.

The pacifier may also include one or more textures that are made of a material harder than a material forming the suction portion.

The pacifier may also include one or more textures where the one or more textures includes a material softer than a material forming the suction portion.

The pacifier may also include where a top surface of the suction portion has a shape that is complimentary to the second side of the guard.

The pacifier may also include where the suction portion is configured to retain a gel.

The pacifier may also include where the one or more textures are disposed on an upper surface of the suction portion and a lower surface of the suction portion.

In yet another aspect, there is a pacifier that includes a guard having a first side and a second side, the guard having one or more rounded edges, a nipple coupled to and extending from the first side of the guard, a suction cup having a top surface and a bottom surface, the suction cup being coupled to and extending from the second side of the guard, where the top surface of the suction cup has a shape that is complimentary to the second side of the guard, where the suction cup contains a plurality of teething elements disposed thereon, where the plurality of teething elements are formed from a material that is harder than a material forming the suction cup, and an extendable connector configured to couple the suction cup to the guard.

The pacifier may also include where the extendable connector is retractable.

The pacifier may also include where the extendable connector is stretchable.

The pacifier may also include where the plurality of teething elements are disposed on a top surface of the suction cup.

The pacifier may also include where the retraction mechanism allows for the suction portion to be retractably coupled to the guard and nipple portion.

The pacifier may also include where the suction cup has a release tab.

The pacifier may also include where the one or more interior volumes are defined by the suction portion and one or more drains.

The pacifier may also include where the extendable connector has a ratchet mechanism.

Other technical features may be readily apparent to one skilled in the art from the following figures, descriptions, and claims.

In at least one embodiment of the present invention, it is an objection of the invention to have a pacifier that can be used as a teething device.

In at least one embodiment of the present invention, it is an objection of the invention to have a pacifier that can be adhered to a surface.

In at least one embodiment of the present invention, it is an objection of the invention to have a pacifier that is not easily lost.

In at least one embodiment of the present invention, it is an objection of the invention to have a pacifier that allows a parent or caregiver to retain a position of the pacifier when set down or not in use.

In at least one embodiment of the present invention, it is an objection of the invention to have a pacifier that can be chilled to help relieve teething pain.

In at least one embodiment of the present invention, it is an objection of the invention to have a pacifier that is lightweight and readily used and manipulated by the infant.

In at least one embodiment of the present invention, it is an objection of the invention to have a pacifier that helps to develop an infant's fine motor skills.

### BRIEF DESCRIPTION OF THE DRAWINGS

To easily identify the discussion of any particular element or act, the most significant digit or digits in a reference number refer to the figure number in which that element is first introduced.

FIG. 1 illustrates a perspective view of a pacifier of an embodiment of the present invention.

FIG. 2 illustrates a side view of a pacifier of an embodiment of the present invention.

FIG. 3 illustrates a rear view of a pacifier of an embodiment of the present invention.

FIG. 4 illustrates a second side view of a pacifier of an embodiment of the present invention.

FIG. 5 illustrates a teething portion with a drain of a pacifier of an embodiment of the present invention.

FIG. 6A illustrates a pacifier of an embodiment of the present invention is a resting or retracted state.

FIG. 6B illustrates a pacifier of an embodiment of the present invention in an elongated or extended state.

FIG. 7 illustrates a ratchet mechanism of an embodiment of the present invention.

FIG. 8 illustrates a perspective view of an embodiment of the present invention.

FIG. 9 illustrates a top view of the embodiment shown in FIG. 8.

FIG. 10 illustrates a sectional side view of the embodiment shown in FIG. 8.

### DETAILED DESCRIPTION OF THE EMBODIMENTS

The invention will now be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

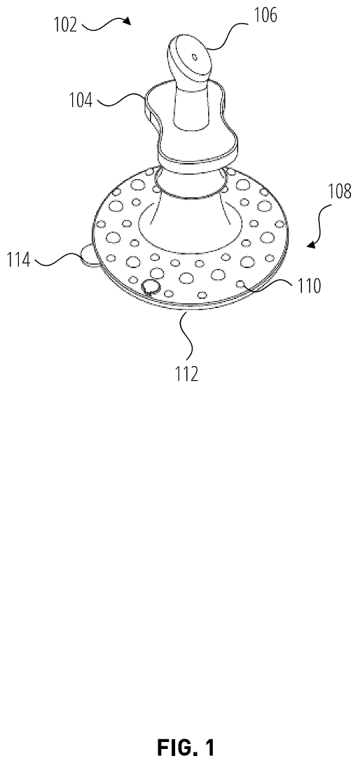

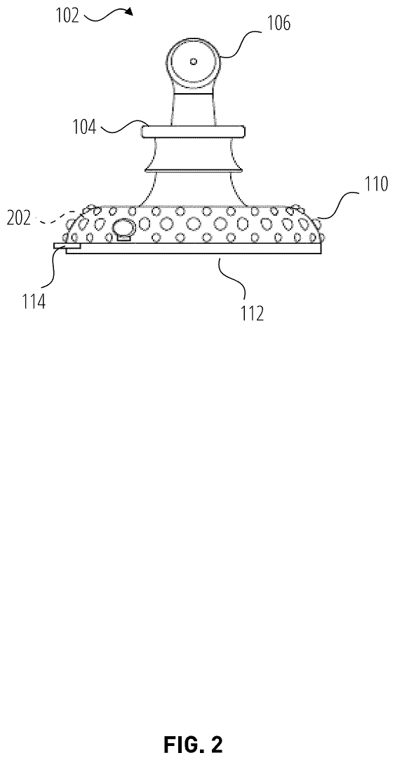

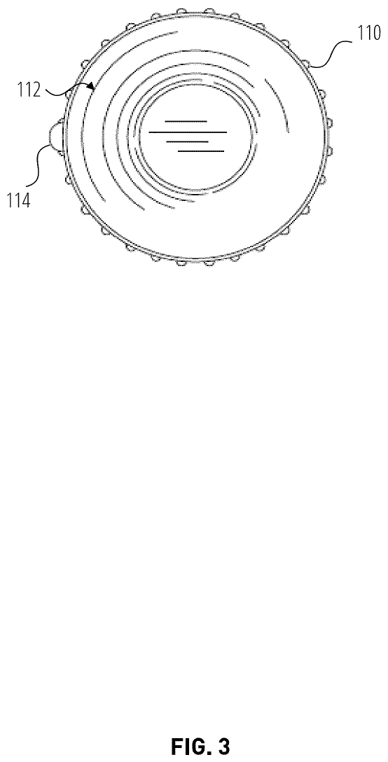

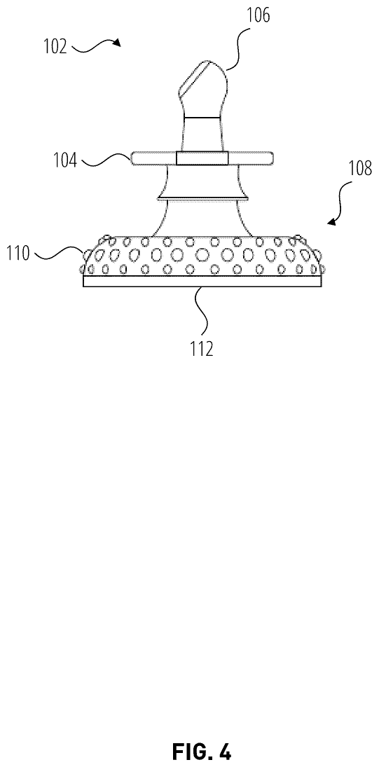

Referring now to FIGS. 1-4, there is a pacifier 102 having a guard 104, nipple portion 106, suction portion 108, one or more textures 110, suction cup 112, and a release tab 114.

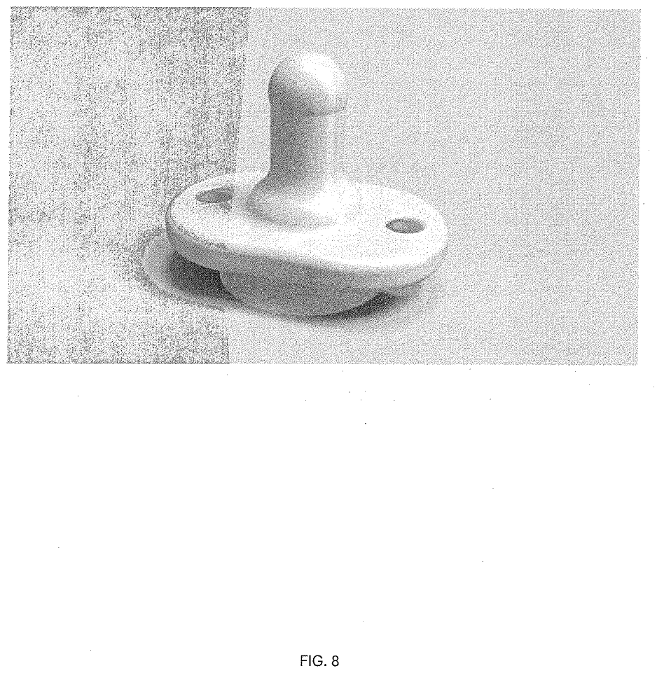

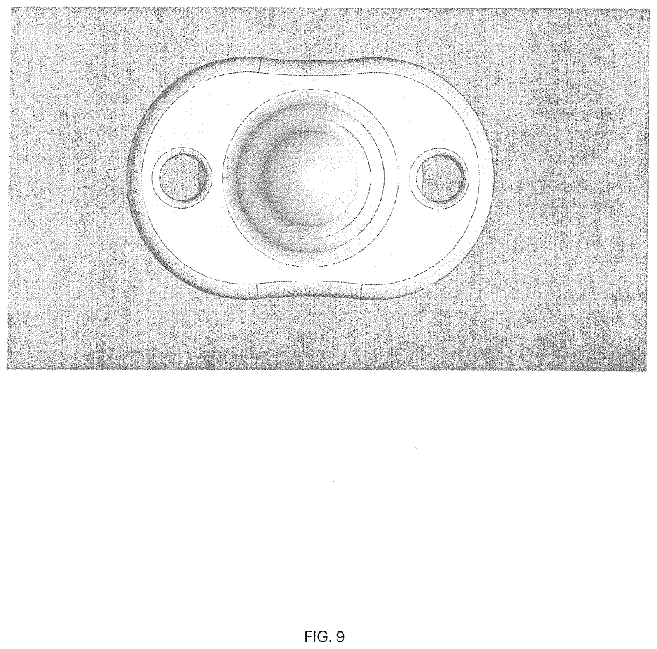

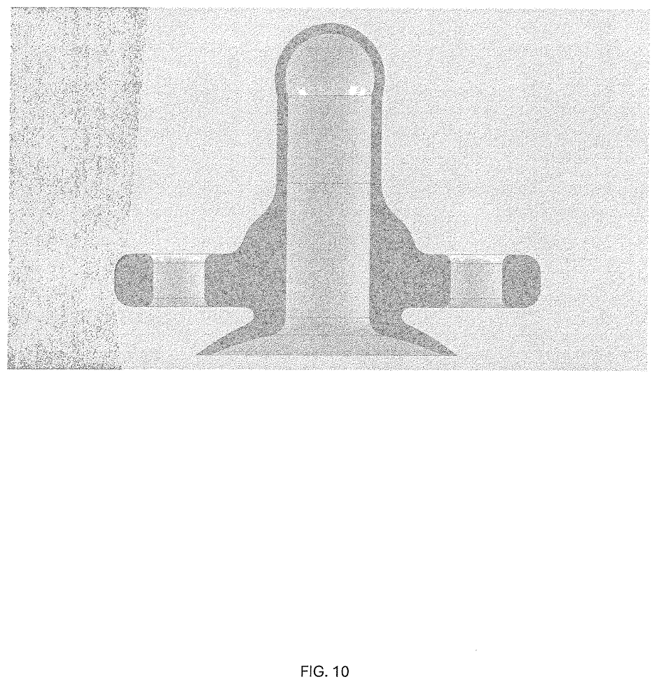

The nipple portion 106 may be coupled to the guard 104 in such a way that prevents removal of the nipple portion 106 from the guard 104 to prevent choking, etc. The nipple portion 106 and guard 104 may take the form of a traditional nipple portion 106 and guard 104 associated with known pacifiers. However, it is noted that while the guard 104 and nipple portion 106 of the pacifier 102 are shown in the drawings as having a specific construction and configuration, it is contemplated that any nipple portion 106 and/or guard 104 may be used in combination with the various embodiments of the present invention. In at least one embodiment, the pacifier 102 may comprise a guard 104, nipple portion 106, suction portion 108, one or more suction cups 112, and a release tab 114 all formed from the same material and preferably from silicone. In other embodiments, other combinations of materials may be used. In such embodiments, the guard 104 may be substantially solid, whereas the nipple portion 106 may be hollow. This hollow may extend through a central portion of the guard 104 and create an opening in the suction cup 112 as shown in FIGS. 8-10.

The guard 104 as shown has a first side and a second side. To one of the first side and the second side the nipple portion 106 is attached to the guard 104. The nipple portion 106 may be attached to the guard 104 via conventional means. The guard 104 may have apertures or holes designed to let saliva or air through to enable an infant to easily breathe while the pacifier 102 remains in the infant's mouth. Further, the guard 104 may have teething structures thereon as further described herein.

The nipple portion 106 extends for a length from either of the first side or the second side of the guard 104. The nipple portion 106 may have various textures disposed thereon or may generally be smooth. The shape and size of the nipple portion 106 may vary depending on the age of the child or other factors.

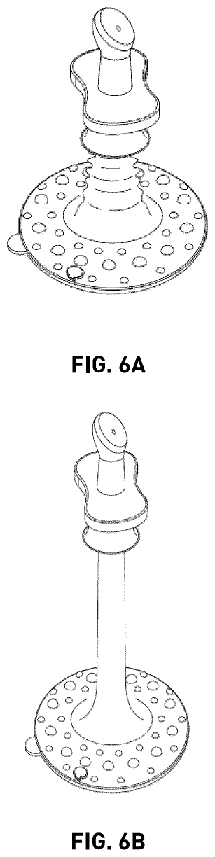

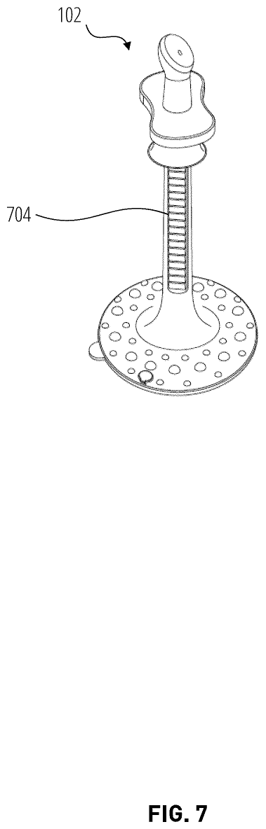

The suction portion 108 comprises a neck or coupling structure, a suction cup 112, one or more textures 110, and a release tab 114. The neck or coupling structure is preferably coupled to the guard 104 on an opposing side of the guard 104 from the nipple portion 106. As described herein in FIGS. 6A-7, the neck portion may comprise an elastic material or a ratchet mechanism that allows for changes in length along the neck portion to provide entertainment to an infant or for practical use purposes.

Below the neck portion is the suction cup 112 having a top surface and a bottom surface. The top surface of the suction cup 112 and the bottom surface of the suction cup 112 may be directly affixed to one another or may be coupled to one another to permit the desired function of the pacifier 102. In one embodiment, the top surface of the suction cup 112 has one or more textures 110 integrated thereon.

The one or more textures 110 preferably comprise a plurality of teething elements. In at least one embodiment, the plurality of teething elements take the form of a plurality of annularly shaped, raised textures. These raised textures may take other shapes and sizes. In some embodiments, the plurality of teething elements combines multiple shapes and sizes of raised textures whereas in other embodiments, the raised textures are uniform in shape and size. Depending on the materials forming the top surface of the suction cup 112 and the one or more textures 110 the material forming the one or more textures 110 may be harder or softer than the surrounding material. For example, in a preferred embodiment, the material forming the one or more textures 110 is harder than the surrounding material forming the top surface of the suction cup 112. This allows for an infant to effectively use the top surface of the suction cup 112 to use it as a teething apparatus. Additionally, the one or more textures 110 may be present on a portion of the upper surface of the suction cup 112 or may be spread across an entire upper surface of the suction cup 112. The spread of the one or more textures 110 may further be uniform in nature or more disjointed to create a unique tactile experience for the infant. It is contemplated that most any arrangement of textures is covered under the purview of this application.

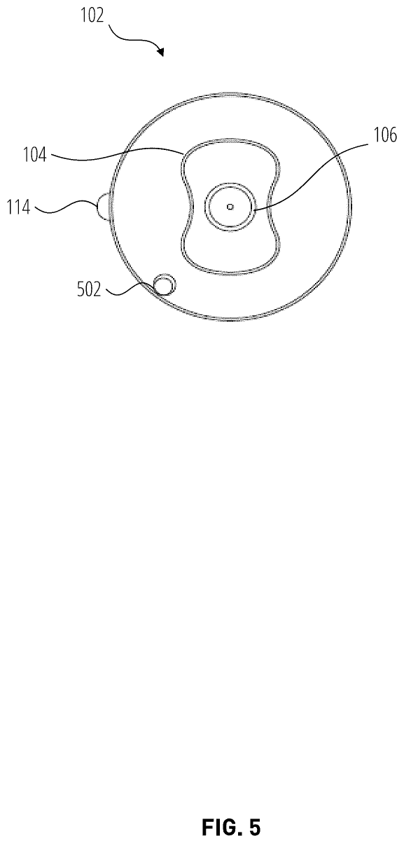

In some embodiments, the one or more textures 110 are fluid filled (e.g., water, gel, etc.) textures that are sealed from one another. Such a fluid allows for the suction portion 108 to be heated or chilled thereby imparting a temperature different from that of the surrounding environment to the one or more textures 110. This further increases the functionality and comfort of using the same as a teething apparatus. However, in other embodiments, such as the embodiment described in FIG. 5, the entire upper portion of the suction cup 112 may be capable of receiving such a fluid thereby allowing the entire device to be heated or chilled and retain that temperature for an amount of time as opposed to primarily the one or more textures 110.

The underside or bottom surface of the suction cup 112 preferably comprises the working portion of the suction cup 112. The suction cup 112 may operate by simply pressing the suction cup 112 to a desired surface thereby causing suction to adhere the pacifier 102 to the desired surface. The suction can then be released and the pacifier 102 removed from the surface by lifting upwardly on or otherwise manipulating the release tab 114. In other embodiments, additional elements may be utilized to generate suction such as a lever which, when manipulated, generates suction between the suction cup 112 and the desired surface. Such a lever can also be used by the infant to manipulate and develop motor skills. In yet other embodiments, the suction cup 112 may comprise two or more suction cups coupled to the guard 104. In multiple suction cup embodiments, the suction cups may be strategically positioned to increase overall suction and/or provide additional securement of the pacifier 102. Further, in some embodiments, the suction cup 112 is removable and/or repositionable. In some instances, the modular nature may extend to other structures of the pacifier 102 (e.g., nipple portion, guard, etc.).

The release tab 114 of the suction cup 112 is intended to “break” the suction seal between the suction cup 112 and the desired surface. By simply lifting upwards on the release tab 114 the seal is broken thereby allowing a parent or caregiver the ability to lift the pacifier 102 from the surface. Preferably, the release tab 114 is an extension or flap of material of the suction cup 112 but can also be a separate material from that of the suction cup 112.

As shown in FIG. 5, there is an alternate embodiment of the present invention showing an underside of the suction portion 108. Shown is the suction cup 112, one or more textures 110, release tab 114, and one or more drains 502. In such an embodiment, the suction portion 108 has an interior volume defined by a portion of the suction cup 112 and one or more textures 110. A hollow or void therein allows for a liquid such as a gel 202 to be contained therein. In other embodiments, water or other suitably heat/cold receptive material(s) may be used therein. One or more drains 502 located in a portion of the suction portion 108 allows for the hot/cold receptive material(s) to be inserted and/or removed from the pacifier 102.

This allows for a multi-functional device as well as for various materials to be chosen by the user to be used therein. For example, water may be chosen as it can be frozen as well as make noise when liquid thereby being used, when cold, to help sooth an infant's gums/teeth and as the frozen water melts, then create a sound that the infant can interact.

It is preferred that the one or more drains 502 are strategically located such that it ensures an easy to clean pacifier 102 as well as making it easy to insert and remove the hot/cold receptive material(s). The one or more drains 502 have a closure mechanism that retains the hold/cold receptive material(s) within the pacifier 102 and prevents the infant from intentionally or accidentally dislodging or opening the one or more drains 502. Such a closure mechanism may be a threaded cap, friction fit mechanism, locking mechanism, and the like or some combination thereof.

FIGS. 6A and 6B, show the “elastic” properties of the pacifier 102. In such an embodiment, the pacifier 102 may exhibit such elastic properties as an interactive element for the infant as well as to prevent breakage of the pacifier 102 and to assist in removal of the pacifier 102 from its point of attachment to an environmental object via the suction cup 112.

FIG. 6A shows pacifier 102 in a resting or retracted state. Such a state refers to the natural elasticity of the material of the suction portion 108 without any external manipulation or influence (e.g. force) exerted thereon. The length of the suction portion 108 of the pacifier 102 in said resting state may vary but is preferably in accordance with those previously described herein above.

FIG. 6B shows the pacifier 102 in an elongated or extended state. In such a state the length of the suction portion 108 may extend to about two to five times (2-5×) the length of the suction portion 108 in the resting state. It is preferable that only the suction portion 108 be capable of extending in such a manner and the nipple portion 106 and guard 104 are largely static or in any event capable of extending less than two times (2×) the respective resting state. As described, this elasticity of the suction portion 108 permits the pacifier 102 to be interacted with by the infant once adhered to an environmental surface without damaging the pacifier 102.

In some embodiments, the relationship between the suction cup 112 and the suction portion 108 may be such that the suction cup 112 is intended to release once the force applied to the suction portion 108 causes the suction portion to reach a percentage of the total maximum extension. For example, the suction cup 112 may be configured to have a discrete amount of suction that can be overcome once a certain amount of force is applied to it to prevent breakage of the pacifier 102. However, in other embodiments, the pacifier 102 cannot conventionally be released by application of force without the aid of the release tab 114. This prevents the pacifier 102 from accidentally becoming dislodged from the surface and becoming lost.

As opposed to the “elastic” properties as shown in FIGS. 6A-B, there may also be a ratchet mechanism 702 which allows for more interactive play for an infant as well as the ability to more finely control an overall length of the pacifier 102.

The ratchet mechanism 702 may comprise a ratchet and a length of material. The ratchet may be coupled to the suction portion 108 or to the guard 104. The length of material is then coupled on one end to the ratchet mechanism and on the other end to the guard 104 or the suction portion 108 whichever is opposite from the ratchet mechanism. In a preferred embodiment, when one applies a force to separate the guard 104/nipple portion 106 from the suction portion 108, the length of material feeds from the ratchet mechanism. The ratchet mechanism may permit incremental length increases of 0.1 mm, 0.2 mm, 0.3 mm, 0.4 mm, 0.5 mm, 0.6 mm, 0.7 mm, 0.8 mm, 0.9 mm, etc. or other divisions of length along the length of material. At or near the end of the extendable length of the length of material, the ratchet mechanism causes the length of material to retract. Once retracted, the same lengthening process can be done as desired by the parent of caregiver or for fun by the infant to help develop fine motor skills.

It should be understood that the foregoing description is only illustrative of the invention. Various alternatives and modifications can be devised by those skilled in the art without departing from the spirit of the invention. Accordingly, the present invention is intended to embrace all such alternatives, modifications and variances which fall within the scope of the appended claims.

1. A pacifier comprising:
a guard having a first side and a second side, the guard having one or more rounded edges;
a nipple portion coupled to and extending from the first side of the guard;
a suction portion coupled to and extending from the second side of the guard,
wherein the suction portion contains an element configured to provide suction when pressed onto a surface.

2. The pacifier of claim 1 wherein the suction portion contains one or more interior volumes configured to receive a fluid.

3. The pacifier of claim 1 wherein the suction portion contains one or more textures disposed thereon.

4. The pacifier of claim 1 wherein the nipple portion is hollow.

5. The pacifier of claim 4 wherein the hollow in the nipple portion extends through a central portion of the guard and the element configured to provide suction.

6. The pacifier of claim 3 wherein the one or more textures comprises one or more annularly shaped raised bumps.

7. The pacifier of claim 1 wherein the suction portion is removable from the guard.

8. The pacifier of claim 1 wherein the element configured to provide suction has a release tab.

9. The pacifier of claim 2 wherein the one or more interior volumes are defined by the suction portion and one or more drains.

10. A pacifier comprising:
a guard having a first side and a second side, the guard having one or more rounded edges;
a nipple coupled to and extending from the first side of the guard;
a suction element coupled to and extending from the second side of the guard,
wherein the suction element contains a suction mechanism configured to provide suction when pressed onto a surface, and
wherein a hollow in the nipple extends through a central portion of the guard and the suction mechanism.

11. The pacifier of claim 10 further comprising one or more textures disposed on the suction element, and wherein the one or more textures comprises a material harder than a material forming the suction portion.

12. The pacifier of claim 11 wherein the one or more textures comprises a material softer than a material forming the suction portion.

13. The pacifier of claim 10 wherein a top surface of the suction element has a shape that is complimentary to the second side of the guard.

14. The pacifier of claim 10 wherein the suction element is configured to retain a gel.

15. The pacifier of claim 11 wherein the one or more textures are disposed on an upper surface of the suction portion and a lower surface of the suction portion.

16. A pacifier comprising:
a guard having a first side and a second side, the guard having one or more rounded edges,
wherein the first side of the guard is on an opposing side of the guard from the second side of the guard, and
wherein the guard has a first aperture and a second aperture, with each of the first aperture and the second aperture extending from the first side of the guard to the second side of the guard;
a hollow nipple coupled to and extending outwardly away from the first side of the guard, wherein the hollow nipple has a diameter greater where the hollow nipple is coupled to the guard than at an opposing end of the hollow nipple, and wherein the hollow nipple has a rounded tip;
a suction cup having a top surface and a bottom surface, the suction cup being coupled to and extending outwardly from the second side of the guard,
wherein the top surface of the suction cup has a shape that is complimentary to the second side of the guard,
a release tab coupled an edge of the suction cup,
wherein manipulating the release tab is configured to release suction formed by the suction cup and a secondary surface;
wherein a hollow in the hollow nipple extends through a center of the guard and the suction cup; and
wherein the nipple, the guard, and the suction cup are formed from silicone.

17. (canceled)

18. (canceled)

19. (canceled)

20. The pacifier of claim 16 further comprising a plurality of teething elements disposed on a top surface of the suction cup.
